(19) United States
(12) Patent Application Publication
(10) Pub. No.: US 2024/0182764 A1
(43) Pub. Date: Jun. 6, 2024

(54) ADHESIVE PRECURSOR COMPOSITION AND HEAT-EXPANDABLE TEMPORARY ADHESIVE THEREFROM

(71) Applicant: 3M INNOVATIVE PROPERTIES COMPANY, St. Paul, MN (US)

(72) Inventor: Kazuki Noda, Tokyo (JP)

(21) Appl. No.: 18/284,189

(22) PCT Filed: Mar. 28, 2022
(86) PCT No.: PCT/IB2022/052844

§ 371 Date: Sep. 26, 2023

Related U.S. Application Data
(60) Provisional application No. 63/168,152, filed on Mar. 30, 2021.

(51) Int. Cl. C09J 133/00; B32B 7/12; B32B 37/12; C09J 4/06; C09J 5/06

(52) U.S. Cl. CPC C09J 133/00; B32B 7/12; B32B 37/12; C09J 4/06; C09J 5/06; B32B 2309/02; B32B 2333/04; C09J 2301/502; C09J 2433/00

(57) ABSTRACT

The present disclosure provides an adhesive precursor composition, comprising a polyfunctional acrylate oligomer, a reactive diluent including an acrylate monomer; a photoinitiator, and heat-expandable microspheres which are capable of expanding above an expansion initiation temperature, Tᵢ, wherein the adhesive precursor composition is a liquid at temperature, Tₐ, wherein Tₐ is less than Tᵢ, and the reaction product of the adhesive precursor composition is a heat-expandable temporary adhesive having a maximum value of tan δ at a temperature, T_{tan δ max}, wherein T_{tan δ max} is less than Tᵢ. In another aspect, the present disclosure provides a heat-expandable temporary adhesive including the reaction product of an adhesive precursor composition according to any one of the adhesive precursor compositions of the present disclosure.

### FIELD OF THE DISCLOSURE

The present disclosure relates to an adhesive precursor composition and a heat-expandable temporary adhesive therefrom, suitable for the temporary bonding of substrates. The disclosure also provides articles prepared therefrom and a method of use of the expandable temporary adhesive.

### BACKGROUND

In the semiconductor processing industry, thickness reduction in silicon wafers has become an important approach in achieving three-dimensional, high density, thin form-factor packages. Thickness reduction is performed by grinding away the rear surface of a silicon wafer, opposite of the surface on which integrated circuitry is placed. In ultrathin wafers, thicknesses of less than 50 μm, in some cases less than 10 μm, are required. At such low thicknesses, the wafers are highly fragile. The stress of thinning processes and downstream metallization can result in additional stress contributing to warpage or breakage, and thus diminishing yields.

To achieve precise levels of thickness reduction, temporary adhesives used to secure wafers during the chip manufacturing process have undergone constant development. WO2000040648A1 describes heat debondable adhesives comprising epoxy resins in which heat expandable inorganic materials are distributed. More recently, commercial solutions employing a light to heat conversion coating has been made available. The coating is typically a solvent based acrylic solution that enables stress free, room temperature debonding of adhesive to a glass carrier interface with laser irradiation. U.S. Pat. No. 8,800,631 describes the use of adhesives for immobilizing wafers of 50 μm thickness that are subsequently ground to 25 μm in which a photo thermal conversion layer and a joining layer comprising acrylates are used. To debond the adhesive, a laser beam source is used to irradiate a photo thermal conversion layer and thus decompose the photo thermal conversion layer.

It is desirable to improve adhesive systems used in, for example, ultrathin wafer processing, by providing an adhesive that debonds in a way that minimizes mechanical stress on a substrate, e.g. a wafer, during debonding. Furthermore, it is desirable that such an adhesive is readily cured, has suitable rheology, is sufficiently tough, and can withstand elevated process temperatures.

### SUMMARY OF INVENTION

In one aspect, the present disclosure provides an adhesive precursor composition, comprising a polyfunctional acrylate oligomer, a reactive diluent including an acrylate monomer, a photoinitiator; and heat-expandable microspheres which are capable of expanding above an expansion initiation temperature, Tᵢ, wherein the adhesive precursor composition is a liquid at temperature, Tₐ, wherein Tₐ is less than Tᵢ, and the reaction product of the adhesive precursor composition is a heat-expandable temporary adhesive having a maximum value of tan δ at a temperature, T_{tan δ max}, wherein T_{tan δ max} is less than Tᵢ. In another aspect, the present disclosure provides a heat-expandable temporary adhesive including the reaction product of an adhesive precursor composition according to any one of the adhesive precursor compositions of the present disclosure. In another aspect, the present disclosure provides an article including a first substrate, a second substrate; and a heat-expandable temporary adhesive disposed therebetween, wherein the heat-expandable temporary adhesive is the reaction product of an adhesive precursor composition according to any one of the adhesive precursor compositions of the present disclosure. In yet another aspect, the present disclosure provides a method of temporarily bonding two substrates, including providing a first and second substrate, applying an adhesive precursor composition according to any one of the adhesive precursor compositions of the present disclosure onto a surface of the first substrate, contacting a surface of the second substrate to the exposed surface of the adhesive precursor composition, and subjecting the adhesive precursor composition to actinic radiation to cure the adhesive precursor composition, thereby forming a heat-expandable temporary adhesive that temporarily bonds the first and second substrates together. The method may further include heating the heat-expandable temporary adhesive to a temperature, T, greater than Tᵢ, thereby expanding the heat-expandable microspheres, causing the heat-expandable temporary adhesive to expand, forming an expanded adhesive which facilitates debonding of at least one of the first and second substrates from the expanded adhesive.

### BRIEF DESCRIPTION OF THE DRAWINGS

FIG. 1 is a schematic, cross-sectional diagram of an exemplary adhesive precursor composition, in accordance with some embodiments of the present disclosure.

FIG. 2 is a schematic, cross-sectional diagram of a heat-expandable temporary adhesive, in accordance with some embodiments of the present disclosure.

FIG. 3 is a schematic, cross-sectional diagram of an article, in accordance with some embodiments of the present disclosure.

FIGS. 4A to 4D show a method of temporarily bonding two substrates, in accordance with some embodiments of the present disclosure.

### DETAILED DESCRIPTION

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better explain the invention and is not be construed as a limitation on the scope of the invention unless otherwise claimed. No language in the specification should be construed as indicating any non-claimed element as essential to the practice of the invention.

An adhesive precursor composition is described which, after curing, provides a heat-expandable temporary adhesive that is useful for temporarily bonding a first and a second substrate, for example temporarily bonding a silicon wafer or semiconductor wafer to a glass panel or carrier. While bonded together, one of the substrates, e.g. a glass panel, may be used to provide support and/or stability, to a more fragile or dimensionally unstable substrate, e.g. a silicon wafer or semiconductor wafer, which may require further processing. For example, a glass panel or carrier may provide support for a silicon wafer during a thinning process that reduces the thickness of the silicon wafer via the removal of material through a grinding or polishing process. After processing, removal of the support substrate is necessary and must be accomplished without damaging the substrate to which it is attached. In the embodiments of the present disclosure, an adhesive precursor composition includes heat-expandable microspheres which are capable of expanding above an expansion initiation temperature, Tᵢ. The adhesive precursor composition may be disposed between and in contact with a surface of a first substrate and a surface of a second substrate and then may be cured by exposure to actinic radiation, forming a heat-expandable temporary adhesive that temporarily bonds the first and second substrates. The heat-expandable temporary adhesive may have a maximum value of tan δ at a temperature, T_{tan δ max}, wherein T_{tan δ max} is less than Tᵢ. Upon exposure to a heat source that increases the temperature, T, of heat-expandable temporary adhesive to a temperature greater than Tᵢ, the heat-expandable microspheres of the heat-expandable temporary adhesive expand, i.e. increase in volume, causing the heat-expandable temporary adhesive to expand, forming an expanded adhesive. This expansion and formation of an expanded adhesive facilitates debonding of at least one of the first and second substrates from the expanded adhesive. Subsequently, the substrates are debonded from each other. Throughout this disclosure, facilitating debonding includes at least one of (i) decreasing the adhesion between at least one of the first substrate and the expanded adhesive and the second substrate and the expanded adhesive, (ii) detaching, i.e. spontaneous debonding, at least one of the first substrate from the temporary adhesive and the second substrate from the temporary adhesive, (iii) causing cohesive failure in the temporary adhesive, and (iv) peeling the temporary adhesive from one of the first and second substrates without damaging the at least one of the first and second substrates. In some embodiments, expansion of the heat-expandable temporary adhesive results in the detaching, e.g. spontaneous debonding, of at least one of the first substrate and second substrate from the expanded adhesive, such that minimal force is required to remove at least one of the first substrate and second substrate from the expanded adhesive. In some embodiments, minimal force may mean that the force of gravity is sufficient to cause debonding and/or a peel force of less than 0.1 N/cm, less than 0.01 N/cm or even less than 0.004 N/cm is sufficient to cause debonding. In some embodiments, once the first or second substrate is debonded from the expanded adhesive, the expanded adhesive is exposed and may be peeled away from the other substrate.

In one embodiment, the present disclosure provides an adhesive precursor composition comprising a polyfunctional acrylate oligomer, a reactive diluent including an acrylate monomer, a photoinitiator; and heat-expandable microspheres which are capable of expanding above an expansion initiation temperature, Tᵢ, wherein the adhesive precursor composition is a liquid at temperature, Tₐ, wherein Tₐ is less than Tᵢ, and the reaction product of the adhesive precursor composition is a heat-expandable temporary adhesive having a maximum value of tan δ at a temperature, T_{tan δ max}, wherein T_{tan δ max} is less than Tᵢ. In some embodiments, T_{tan δ max} is at least 10° C. less than Tᵢ, at least 20° C. less than Tᵢ or even at least 30° C. less than Tᵢ. In some embodiments, Tₐ is at least 10° C. greater, at least 20° C. greater or even at least 30° C. greater than a melting point of the adhesive precursor composition. In some embodiments, Tₐ may be at least 25° C., at least 35° C. or at least 45° C. In some embodiments, Tₐ may be between 25° C. and 80° C. In some embodiments, the difference, Tᵢ−T_{tan δ max}, may between 50° C. to 200° C., 70° C. to 180° C. or even 90° C. to 160° C. In some embodiments, the viscosity of the adhesive precursor composition is between 500 cp and 30,000 cp at a temperature between 0° C. and 80° C.

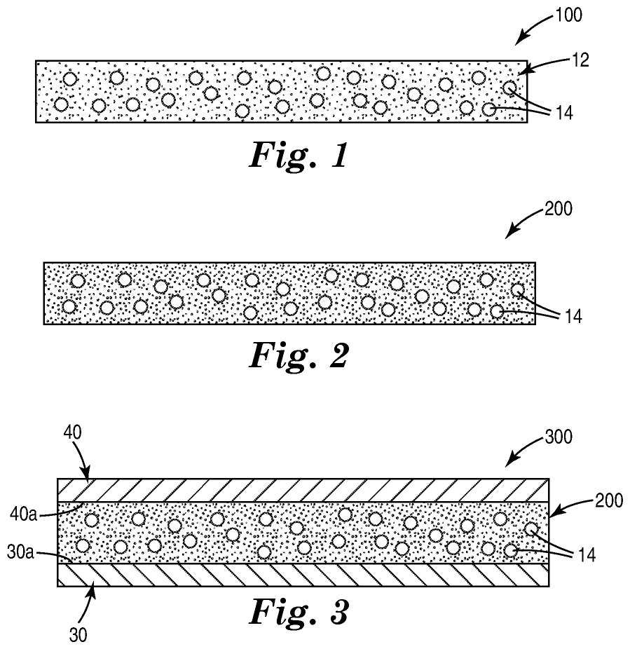

FIG. 1 shows a schematic, cross-sectional diagram of an exemplary adhesive precursor composition, in accordance with some embodiments of the present disclosure. Adhesive precursor composition 100 includes a curable matrix 12 and heat-expandable microspheres 14. Curable matrix 12 incudes a polyfunctional acrylate oligomer, a reactive diluent including an acrylate monomer and a photoinitiator. The heat-expandable microspheres 14 are contained in curable matrix 12 and may be homogenously dispersed therein. The heat expandable microspheres have an expansion initiation temperature Tᵢ, at which the microspheres start expanding. In some embodiments, the thickness of the adhesive precursor composition is between 1 μm and 1,000 μm, between 10 μm and 750 μm or between 25 μm and 500 μm. Adhesive precursor composition 100 may be cured, for example by exposure to actinic radiation, forming a heat expandable temporary adhesive.

In another embodiment, the present disclosure provides a heat-expandable temporary adhesive comprising the reaction product according to any one of the adhesive precursor compositions of the present disclosure. FIG. 2 is a schematic, cross-sectional diagram of a heat-expandable temporary adhesive, in accordance with some embodiments of the present disclosure. Heat-expandable temporary adhesive 200 includes heat-expandable microspheres 14. Heat-expandable temporary adhesive is polymeric and may exhibit viscoelastic behavior.

Viscoelastic behavior may be characterized by various parameters including, for example, loss modulus, elastic modulus and tan δ. As used herein, tan δ is an abbreviation of the term “tangent of delta”, which is defined as the ratio of the viscous to elastic response of a polymer, (e.g. the ratio of loss modulus to elastic modulus as measured in a DMTA test, for example) which has a physical relationship to the energy dissipation potential of a material. The components of the adhesive precursor composition may be selected to achieve a specific set of viscoelastic properties for the adhesive precursor composition and also for the cured adhesive, i.e. the heat-expandable temporary adhesive. In some embodiments, the adhesive precursor composition has a viscoelastic loss factor, tan δ, greater than 1, at a temperature at which the precursor composition is to be applied, which may be room temperature. This provides for an adhesive precursor composition that behaves like a liquid at room temperature or the application temperature, for ease of dispensing and spreading. In some embodiments, the value of tan δ of the heat-expandable temporary adhesive is less than 1 at temperatures between the application temperature of the adhesive precursor composition and Tᵢ. This property signifies that the heat-expandable temporary adhesive behaves like a solid after curing. Third, when it is desired to debond the heat-expandable temporary adhesive from a substrate, heat is supplied to the heat-expandable temporary adhesive, causing it to soften as its temperature moves above its glass transition temperature, T_{g}, thus enabling the heat-expandable temporary adhesive to exhibit some flow characteristics. i.e. some liquid like behavior indicative of a polymer's viscoelastic properties.

The components of the adhesive precursor composition, including the heat-expandable microspheres, may be selected to meet the desired viscoelastic properties. This enables the desired sequential transition of characteristics ideal for debonding to be achieved. When the heat-expandable temporary adhesive is first heated above T_{tan δ max}, the amorphous regions of the cured adhesive becomes soft and capable of limited flow (viscoelastic). As the temperature increases further, the initiation temperature, Tᵢ, of the heat-expandable particles is reached. As the adhesive has been rendered soft and capable of some flow, the expanding particles generate sufficient force to expand the cured adhesive and facilitate debonding of a substrate attached thereto.

The adhesive precursor compositions and the heat-expandable adhesives therefrom are particularly well suited for the bonding of substrates, including the temporary bonding of substrates, thereby forming an article. In another embodiment, the present disclosure provides an article including a first substrate, a second substrate and a heat-expandable temporary adhesive disposed therebetween, wherein the heat-expandable temporary adhesive is the reaction product of an adhesive precursor composition according to any one of the adhesive precursor compositions of the present disclosure. FIG. 3 is a schematic, cross-sectional diagram of an article, in accordance with some embodiments of the present disclosure. FIG. 3 shows article 300 which includes heat expandable temporary adhesive 200 containing heat expandable microspheres 14, first substrate 30 having a surface 30a and second substrate 40 having a surface 40a. Surfaces 30a and 40a are in contact with heat expandable temporary adhesive 200 which bonds first substrate 30 and second substrate 40 together.

The first and second substrates are not particularly limited and may include, but are not be limited to, at least one of a metal, a polymer, e.g. a thermoplastic or thermoset, and a ceramic. In some embodiments, at least one of the first and second substrate may be opaque. In some embodiments, at least one of the first and second substrate may be optically clear and/or transparent to actinic radiation, i.e. allows actinic radiation to pass through its body. In one embodiment, the first substrate may be opaque and the second substrate may be optically clear and/or transparent to actinic radiation. In another embodiment, the first substrate may be optically clear and/or transparent to actinic radiation and the second substrate may be opaque. Throughout this disclosure, the phrase “transparent to actinic radiation” means that the substrate is at least partially transparent to actinic radiation, i.e. allowing at least 25%, at least 50% or even at least 75% transmission of at least some wavelengths associated with actinic radiation to pass through its body. Actinic radiation may include electromagnetic radiation in the UV, e.g. 100 to 400 nm, and visible range, e.g. 400 to 700 nm, of the electromagnetic radiation spectrum.

In some embodiments, at least one of the first and second substrates includes topography (not shown in FIG. 3), e.g. topography related to the integrated circuitry of a semiconductor wafer. In some embodiments, the first substrate may be a silicon wafer or a semiconductor wafer and the second substrate may be a glass panel or glass support. In some embodiments, the first substrate may be a glass panel or glass support and the second substrate may be a silicon wafer or a semiconductor waver. The glass panel or support may be transparent to actinic radiation, i.e. allowing at least 25%, at least 50% or even at least 75% transmission of at least some wavelengths associated with actinic radiation to pass through its body. The thickness of the substrates of the present disclosure is not particularly limited. In some embodiments, the substrates of the present disclosure, e.g. a semiconductor wafer, may have a thickness of less than 1000 μm, less than 750 μm, less than 500 μm, less than 300 μm, less than 100 μm, less than 80 μm or less than 60 μm and/or may have a thickness of greater than 20 μm or greater than 40 μm.

The adhesive precursor compositions of the present disclosure include a polyfunctional acrylate oligomer. The polyfunctional acrylate oligomer is not particularly limited and combinations of polyfunctional acrylate oligomers may be used. In some embodiments, the polyfunctional acrylate oligomer has at least two, at least three or even at least four acrylate groups. The amount of the polyfunctional acrylate oligomer in the adhesive precursor composition may be from 40 wt. % to 70 wt % or 45 wt. % to 65 wt. %, based on the total weight of the adhesive precursor composition. In some embodiments, the polyfunctional acrylate oligomer includes a urethane acrylate oligomer. In certain embodiments, these oligomers are selected to give rise to polymers, e.g. heat-expandable temporary adhesives, that have low modulus, high flexibility, and elasticity, in conjunction with high tear strength and adhesive strength. These qualities facilitate ease of debonding and detachment. Urethane acrylates are used in a variety of specialized acrylate adhesives, such as bonding metal to metal and metal to glass. They may be cured by actinic radiation, e.g. UV/Visible light curing, and/or heat cured.

In general, urethane-acrylate oligomers are produced by the reaction of polyols with isocyanate, and subsequent acrylation by acrylic acid. In a preferred embodiment, the urethane acrylate comprises a polyether urethane acrylate or polyether urethane methacrylate. Polyether urethane acrylate oligomers contain repeating ether units (—R1-O—R2-), for example,

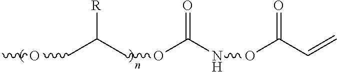

may be obtained by reacting polyether polyols with an aromatic or aliphatic di-functional isocyanate, and subsequently hydroxyl-functional acrylate or acrylic acid. Polyether polyols characteristically provide softer urethane oligomers with superior hydrolytic stability as compared to polyester polyols. It also typically possesses physical properties of moderate peel and tack to high energy surfaces, such as, for example, stainless steel and glass, and is therefore suited to temporary adhesion.

In another embodiment, the urethane acrylate oligomer is selected from a polyester urethane acrylate or methacrylate. Polyester urethane acrylate oligomers containing repeating ester units (—R3-COO—R4-), for example,

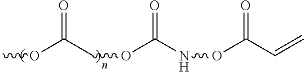

may be obtained by reacting polyester polyols with an aromatic or aliphatic di-functional isocyanate, and subsequent acrylation by hydroxyl-functional acrylate or acrylic acid. Polyester urethane acrylate oligomers typically have a higher adhesive strength and hardness, which may be suitable for adhesion of larger and heavier objects.

With respect to polyfunctional acrylate oligomer, the term oligomer refers to a molecule comprising covalently bonded, repeated monomeric units with number average molecular weights of above 500, above 1,000, or above 2,000 and/or less than 70,000, less than 40,000, less than 20,000, or less than 10,000 g/mol. The term monomer as used herein refers single molecular units that are polymerizable. By selecting suitable moieties for R1, R2, R3 and R4 and by specifying a suitable molecular weight for the oligomer, which may be in the range of 1000 to 50000 g/mol, or preferably 5000 to 40000 g/mol, the resulting adhesive can achieve the desired qualities of softness, flexibility, elasticity and adequate adhesion.

In some embodiments, the urethane acrylate oligomer includes an aliphatic polyfunctional urethane acrylate oligomer, such as aliphatic urethane diacrylate, aliphatic urethane triacrylate, aliphatic urethane tetraacrylate, and aliphatic urethane hexaacrylate. Such oligomers have the simplified formula (I):

Ac-R5-O{[OCHN—R6-NHCO][O—R7-O][OCHN—R6-NHCO]}ₙO—R5-Ac
wherein
Ac: acrylate moiety H2C═CH—COO—,
R5: C1-C7 aliphatic, branched, hydrocarbon moiety, optionally substituted;
OCHN—R6-NHCO: diisocyanate segment from diisocyanate O═C═N—R6-N═C═O,
R6=C1-C30 aliphatic, branched, or aromatic hydrocarbon moiety;
HO—R7-OH: polyol segment from polyol HO—R7-OH,
R7=C1-C30 aliphatic, branched, or aromatic hydrocarbon moiety; and n=10-1000.

Preferred urethane acrylate oligomers comprise high weight fraction of polyols e.g. 1:4, 1:3, 1:2 or 1:1 ratio to diisocyanate, which gives rise to lower glass transition temperature, more soft segments and therefore higher flexibility and elasticity, which may enable easier debonding. Molecular weight of urethane acrylate oligomers may range from 1,000 to 50,000.

Commercial examples of aliphatic urethane acrylate oligomers which may be incorporated into the adhesive precursor composition include those manufactured by Sartomer Co. Inc., Exton, PA, such as difunctional aliphatic urethane acrylate oligomers: CN9002, CN9004, CN9005, CN9007, CN9178, CN9290US, CN940, CN9788, CN9893; trifunctional aliphatic urethane acrylate oligomers such as CN989, CN929; other aliphatic urethane acrylate oligomers such as CN996, CN9009, CN9010, CN3211, CN9001, CN2920; aliphatic polyester based urethane diacrylate oligomer such as CN9011 CN965 CN991, CN980; an aliphatic polyester/polyether based urethane diacrylate oligomer (CN-981, CN964, CN983, CN984, CN968, an aliphatic polyester based urethane hexaacrylate oligomer, a trifunctional aliphatic polyester urethane acrylate oligomer such as CN9008 and others, all available from Sartomer Company, Inc. Soft, elastic urethane acrylates are also commercially available from Mitsubishi Chemical Corp., Tokyo, Japan. as SHIKOH UV-3500BA (butyl acetate), UV-3520EA (ethyl acetate), UV-3200B, and UV-3000B, all polyester urethane acrylates; and SHIKOH UV-3300B and UV 3700B, which are polyether urethane acrylates. In an exemplary embodiment, the acrylate oligomer comprises SHIKOH UV-3700B, a soft-and-elastic-type, UV-curable urethane acrylate oligomer resin having high molecular weight of 30,000 to 50,000, high flexibility and modulus, and good adhesion.

In some embodiments, the polyfunctional acrylate oligomer includes a polyester acrylate oligomer. In another embodiment, as an alternative to or in combination with urethane acrylate oligomers, a polyester acrylate or polyester methacrylate may be used. Polyester acrylates are readily cured and provide high adhesion. In general, suitable polyester acrylate oligomers may be obtained by reacting a polyacid with a polyol, and then with acrylic acid. It may have the formula (II) in which 2 terminal acrylate groups are present:

Ac-R8-O{[OC—R9-CO][O—R10-O][OC—R5-CO]}ₙO—R8-Ac (II)
wherein
Ac: acrylate moiety H₂C═CH—COO—,
R8: C1-C7 aliphatic, branched, hydrocarbon moiety, optionally substituted;
OC—R9-CO: polyacid segment from polyacid HOOC—R9-COOH,
R9=C1-C30 aliphatic, branched, or aromatic hydrocarbon moiety;
O—R10-O: polyol segment from polyol HO—R6-OH,
R10: C1-C30 aliphatic, branched, or aromatic hydrocarbon moiety; and
n=10-1000

In some embodiments, polyester acrylates include highly hydrophobic long aliphatic chain, branched, cyclic and/or aromatic hydrocarbon moieties in the polyol segment that gives rise to rubbery and elastic qualities. Number average molecular weight of polyester acrylate oligomers may range from 1,000 to 50,000 g/mol. Exemplary polyester acrylates include those known under the trade designation PEAM-1769 and PEAM-645, available from Designer Molecules, Inc., San Diego, California.

In some embodiments, the polyfunctional acrylate oligomer is selected from at least one of a polyester acrylate oligomer and a urethane acrylate oligomer. In some embodiments, the polyfunctional acrylate oligomer includes a C31-C80 polyester acrylate oligomer. In some embodiments, the polyfunctional acrylate oligomer includes a C15-C30 urethane acrylate oligomer.

The adhesive precursor compositions of the present disclosure include a reactive diluent. The reactive diluent is not particularly limited and combinations of reactive diluents may be used. The amount of the reactive diluent in the adhesive precursor composition may be from 10 wt. % to 35 wt. % or 15 wt. % to 30 wt. %, based on the total weight of the adhesive precursor composition. Reactive diluents comprising acrylate monomers may be included to facilitate termination and crosslinking of the polyfunctional acrylate oligomers. Aromatic or non-aromatic, monofunctional or difunctional, acrylate or methacrylate monomers may be used. Examples include acrylate esters such as methyl acrylate, ethyl acrylate, n-propyl acrylate, isopropyl acrylate, n-butyl acrylate, isobutyl acrylate, sec-butyl acrylate, tert-butyl acrylate, amyl acrylate, isoamyl acrylate, n-hexyl acrylate, cyclohexyl acrylate, 2-ethylhexyl acrylate, pentadecyl acrylate, dodecyl acrylate, isobornyl acrylate, phenyl acrylate, benzyl acrylate, phenoxyethyl acrylate, 2-hydroxyethyl acrylate, 2-methoxyethyl acrylate, glycidyl acrylate and allyl acrylate; unsaturated carboxylic acids such as methacrylic acid, acrylic acid and maleic anhydride; olefins such as ethylene, propylene, 1-butene, isobutylene and 1-octene. In some embodiments, the reactive diluent includes at least one monofunctional acrylate monomer.

Other examples include methyl methacrylate, isobornyl acrylate and isodecyl acrylate and higher functional monomers such as hexanediol diacrylate and trimethylolpropane triacrylate. In some embodiments, the acrylate monomer includes at least three acrylate groups per molecule.

In some embodiments, the non-aromatic monomer comprises a high glass transition (T_{g}) monomer, having a T_{g} greater than 10° C. and typically of at least 15° C., 20° C., or 25° C., and preferably at least 50° C. Suitable high T_{g} monomers include, for example, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, cyclohexyl methacrylate, isobornyl acrylate, isobornyl methacrylate, norbornyl (meth)acrylate, benzyl methacrylate, 3,3,5 trimethylcyclohexyl acrylate, cyclohexyl acrylate, N-octyl acrylamide, and propyl methacrylate or combinations. In an exemplary embodiment, the acrylate monomer comprises 1,6-hexanediol diacrylate. A commercially available example is VISCOAT #230, HDDA, from Osaka Organic Chemical Industry, Ltd, Osaka, Japan. In another embodiment, the acrylate monomer comprises benzyl acrylate (BZA). A commercially available example is VISCOAT #160, BZA from Osaka Organic Chemical Industry, Ltd. BZA has low viscosity (2.2 cps).

In some embodiments, the ratio of polyfunctional acrylate oligomer to reactive diluent is from 2:1 to 10:1, 2.5:1 to 7.5:1 or 3:1 to 5:1 based on the weight of each component. In some embodiments, the amount of polyfunctional acrylate oligomer is between 40% to 70% by weight of the adhesive precursor composition, and the amount of reactive diluent is between 10% to 35% by weight adhesive precursor composition.

The adhesive precursor compositions of the present disclosure include heat-expandable microspheres. Combinations of different types heat-expandable microspheres may be used. The shape of the heat-expandable microspheres is not particularly limited. The shape of the heat-expandable microspheres may generally be spheroidal. In some embodiments, the amount of the heat-expandable microspheres in the adhesive precursor composition may be from 3 wt. % to 60 wt. %, 3 wt. % to 50 wt. %, 3 wt. % to 45 wt. %, 3 wt. % to 40 wt. %, 3 wt. % to 35 wt. %, 5 wt. % to 60 wt. %, 5 wt. % to 50 wt. %, 5 wt. % to 45 wt. %, 5 wt. % to 40 wt. %, 5 wt. % to 35 wt. %, 10 wt. % to 60 wt. %, 10 wt. % to 50 wt. %, 10 wt. % to 45 wt. %, 10 wt. % to 40 wt. %, 10 wt. % to 35 wt. %, 15 wt. % to 60 wt. %, 15 wt. % to 50 wt. %, 15 wt. % to 45 wt. %, 15 wt. % to 40 wt. %, or 15 wt. % to 35 wt. %, based on the total weight of the adhesive precursor composition. Heat-expandable microspheres are used to facilitate debonding between the cured adhesive and attached substrate. Such microspheres may contain a low-boiling point substance which is vaporized when heated to the expansion initiation temperature Tᵢ. The substance is encapsulated in a thermoplastic shell which softens with heat or a shell which is ruptured by heat expansion. Examples of the vaporizable substance include hydrocarbons, such as isobutane, propane, and heptane. Examples of the polymeric shell include a vinylidene chloride-acrylonitrile copolymer, polyvinyl alcohol, polyvinyl butyral, polymethyl methacrylate, polyacrylonitrile, polyvinylidene chloride, and polysulfone. In some embodiments, the heat-expandable microspheres may have a longest dimension, e.g. diameter, of about 5 μm to 100 m, about 10 μm to 70 μm or from about 20 μm to 40 μm. Heat-expandable microspheres may be capable of expanding to at least 2 times its original longest dimension, at least 3 times its longest dimension, at least 5 times its longest dimension or even more. The expanded size of the microspheres may be greater than 50 μm, greater than 100 μm, greater than 150 μm or greater than 200 microns and/or less than 1,000 μm, less than 800 μm, less than 600 μm or less than 400 μm.

The heat expandable microspheres may include styrene particles impregnated with hydrocarbons. A method for producing expandable discrete styrene-polymer bit-pieces impregnated with a liquid aliphatic impregnant which volatilizes below the softening point of the polymer is described in U.S. Pat. No. 4,018,946, for example.

Heat-expandable microspheres are commercially available, for example, under the trade designation MATSUMOTO MICROSPHERES (manufactured by Matsumoto Yushi-Seiyaku Co., Ltd. Yao-Shi, Japan), EXPANDCEL MICROSPHERES (from Akzo Nobel, Amsterdam, Netherlands), and KUREHA MICROSPHERES (from Kureha Corp., Tokyo, Japan).

In one embodiment, KUREHA MICROSPHERE, H750 (obtained from Kureha Corp.) may be used as the expandable microsphere. The microspheres expand to a target diameter and maintains that diameter after cooling. They are compatible in both binder and fibrous materials and can be compressed during molding and rebound to the intended shape when the pressure is reduced. The microsphere has an initiation temperature, Tᵢ, of 138° C. The unexpanded microsphere diameter is about 20 μm and the expanded diameter is about 75 μm. The expanded microsphere density is less than 0.019 g/cm³. In another embodiment, KUREHA MICROSPHERE S2640 (from Kureha Corp.) may be used as the expandable microsphere. The microsphere has an initiation temperature, Tᵢ, of about 208° C. The unexpanded microsphere diameter is about 21 μm and the expanded diameter is about 131 μm.

In accordance with the present disclosure, the heat-expandable temporary adhesive meets the criteria of T_{tan δ max}<Tᵢ, where T_{tan δ max} is the temperature at which the heat-expandable temporary adhesive's peak Tan δ occurs. For example, if KUREHA MICROSPHERE, H750 is used, then heat-expandable temporary adhesives having T_{tan δ max} a less than 138° C. are used. If KUREHA MICROSPHERE S2640 is used, then heat-expandable temporary adhesives having T_{tan δ max} less than 208° C. are used.

In some embodiments, the heat expandable temporary adhesive may have a single glass transition temperature, i.e. a single T_{tan δ max}. In some embodiments, the heat-expandable temporary adhesive may have two or more glass transitions, depending on the composition of the adhesive precursor composition it was fabricated from. If multiple glass transition temperatures are present in the heat-expandable temporary adhesive, T_{tan δ max} is still defined as the temperature of the maximum value for tan δ. In some embodiments, to achieve the desired debonding sequence, the temperature difference, Tᵢ−T_{tan δ max}, is at least 30° C., at least 40° C., at least 50° C., at least 75° C. or at least 100° C. In some embodiments, the temperature difference, Tᵢ−T_{tan δ max}, is from 30° C. to 200° C., from 50° C. to 200° C., from 50° C. to 160 or from 80-160° C.

The adhesive precursor compositions of the present disclosure are capable of being cured and the curing technique is not particularly limited and may include, for example, curing by actinic radiation, thermal curing, e-beam curing and combinations thereof. A free-radical curing mechanism may be employed and may be initiated by, for example, thermal methods as well as radiation methods, such as electron beam or actinic radiation initiated free radical formation. Actinic radiation may include electromagnetic radiation in the UV, e.g. 100 to 400 nm, and visible range, e.g. 400 to 700 nm, of the electromagnetic radiation spectrum. Due to its rapid cure characteristics, the curing of the adhesive precursor composition by actinic radiation may be preferred.

To facilitate curing, the adhesive precursor compositions of the present disclosure include an initiator, i.e. a polymerization initiator, e.g. a photoinitiator. Combinations of different photoinitiators may be used. The amount of the initiator in the adhesive precursor composition may be from 0.2 wt. % to 10 wt. % or 0.5 wt. % to 5 wt. %, based on the total weight of the adhesive precursor composition.

The adhesive precursor compositions according to the present disclosure may include a photoinitiator. The amount of photoinitiator in the adhesive precursor composition may be less than about 5 wt. %, less than 4 wt. %, or less than 3 wt. % and/or greater than 0.05 wt. %, greater than 0.1 wt. %, greater than 0.3 wt. % or greater than 0.5 wt. %, based on the weight of the adhesive precursor composition, based on the total weight of the adhesive precursor composition.

Useful photoinitiators, e.g. free-radical photoinitiators, include, for example, those known as useful in the UV cure of acrylate polymers. Such initiators include benzophenone and its derivatives; benzoin, alpha-methylbenzoin, alpha-phenylbenzoin, alpha-allylbenzoin, alpha-benzylbenzoin; benzoin ethers such as benzil dimethyl ketal (commercially available under the trade designation “IRGACURE 651” from Ciba Specialty Chemicals Corporation, Tarrytown, N.Y.), benzoin methyl ether, benzoin ethyl ether, benzoin n-butyl ether; acetophenone and its derivatives such as 2-hydroxy-2-methyl-1-phenyl-1-propanone (commercially available under the trade designation “DAROCUR 1173” from Ciba Specialty Chemicals Corporation) and 1-hydroxycyclohexyl phenyl ketone (commercially available under the trade designation “IRGACURE 184”, also from Ciba Specialty Chemicals Corporation); 2-methyl-1-[4-(methylthio)phenyl]-2-(4-morpholinyl)-1-propanone commercially available under the trade designation “IRGACURE 907”, also from Ciba Specialty Chemicals Corporation); 2-benzyl-2-(dimethylamino)-1-[4-(4-morpholinyl)phenyl]-1-butanone commercially available under the trade designation “IRGACURE 369” from Ciba Specialty Chemicals Corporation); aromatic ketones such as benzophenone and its derivatives and anthraquinone and its derivatives; onium salts such as diazonium salts, iodonium salts, sulfonium salts; titanium complexes such as, for example, that which is commercially available under the trade designation “CGI 784 DC”, also from Ciba Specialty Chemicals Corporation); halomethylnitrobenzenes; and mono- and bis-acylphosphines such as those available from Ciba Specialty Chemicals Corporation under the trade designations “IRGACURE 1700”, “IRGACURE 1800”, “IRGACURE 1850”, “IRGACURE 819” “IRGACURE 2005”, “IRGACURE 2010”, “IRGACURE 2020” and “DAROCUR 4265”. Combinations of two or more photoinitiators may be used. Further, sensitizers such as 2-isopropyl thioxanthone, commercially available from First Chemical Corporation, Pascagoula, Miss., may be used in conjunction with photoinitiator(s) such as “IRGACURE 369”. More preferably, the initiators used in the present invention are either “DAROCURE 1173” or “ESACURE® KB-1”, a benzildimethylketal photoinitiator available from Lamberti S.p.A of Gallarate, Spain.

In exemplary embodiments, aminoalkyl phenones such as Omnirad 369, and photo sensitizers such as a thioxanthone are used. In an example, the combination of 8% Ominirad 369 and 2% isopropyl thioxanthone may be used. Commercially available Omnirad 369 (from IGM Resisns B. V., Netherlands) has the structural formula of 2-Benzyl-2-dimethylamino-1-(4-morpholinophenyl)-butanone-1. It is an efficient UV curing agent which is used to initiate the photopolymerisation of chemically prepolymers—e.g. acrylates—in combination with mono- or multifunctional monomers. Another example is Omnirad 851 (obtained from IGM Resins B. V.).

In some embodiments, thermal initiators may also be incorporated into the adhesive precursor composition. Useful free-radical thermal initiators include, for example, azo, peroxide, persulfate, and redox initiators, and combinations thereof. The amount of thermal initiator used may be the same as that disclosed for the photoinitiators.

In some embodiments, sensitizer may also be added to the adhesive precursor composition in an amount as conventionally used in UV radiation curable compositions. The amount of the sensitizer in the adhesive precursor composition may be from 0.2 wt. % to 10 wt. % or 0.5 wt. % to 5 wt. %, based on the total weight of the adhesive precursor composition. Examples of the sensitizer are, for instance, an amino compound such as dimethylaminoethanol, methyl N,N-dimethylaminoanthranilate or ethyldimethylaminobenzoic acid, an acrylic monomer having tertiary amino group such as N,N-dimethyl-aminoethyl acrylate and methacrylate or N,N-dimethylaminopropyl acrylamide and methacrylamide, and other known sensitizers.

Other, optional, additives may be added to the adhesive precursor composition, including a pigment, an inert organic polymer, a levelling agent, a thixotropic thickener, a thermal polymerization inhibitor, a solvent, and other additives, as occasion demands. Those skilled in the art will appreciate that the coating compositions may contain other optional adjuvants, such as, surfactants, antistatic agents (e.g., conductive polymers), leveling agents, photosensitizers, ultraviolet (“UV”) absorbers, stabilizers, antioxidants, lubricants, pigments, dyes, plasticizers, suspending agents and the like. Additives may be included in the adhesive precursor composition in amounts ranging from 1 wt. % to 10 wt. %, based on the total weight of the adhesive precursor composition.

In some embodiments, the adhesive precursor composition may include a solvent. A single organic solvent or a blend of solvents can be employed. Depending on the free-radically polymerizable materials employed, suitable solvents include alcohols such as isopropyl alcohol (IPA) or ethanol; ketones such as methyl ethyl ketone (MEK), methyl isobutyl ketone (MIBK), diisobutyl ketone (DIBK); cyclohexanone, or acetone; aromatic hydrocarbons such as toluene; isophorone; butyrolactone; N-methylpyrrolidone; tetrahydrofuran; esters such as lactates, acetates, including propylene glycol monomethyl ether acetate such as commercially available from 3M Company, St. Paul, MN, under the trade designation “3M SCOTCHCAL THINNER CGS10” (“CGS10”), 2-butoxyethyl acetate such as commercially available from 3M under the trade designation “3M SCOTCHCAL THINNER CGS50” (“CGS50”), diethylene glycol ethyl ether acetate (DE acetate), ethylene glycol butyl ether acetate (EB acetate), dipropylene glycol monomethyl ether acetate (DPMA), iso-alkyl esters such as isohexyl acetate, isoheptyl acetate, isooctyl acetate, isononyl acetate, isodecyl acetate, iododecyl acetate, isotridecyl acetate or other iso-alkyl esters; combinations of these and the like. Solvent may be used to adjust the viscosity of the adhesive precursor composition.

In another embodiment, the present disclosure provides a method of temporarily bonding two substrates. In one embodiment, the method of temporarily bonding two substrates includes providing a first and second substrate, applying an adhesive precursor composition according to any one of adhesive precursor compositions of the present disclosure onto a surface of the first substrate, contacting a surface of the second substrate to the exposed surface of the adhesive precursor composition and curing the adhesive precursor composition, thereby forming a heat-expandable temporary adhesive that temporarily bonds the first and second substrates together. In another embodiment, the method of temporarily bonding two substrates includes providing a first and second substrate, applying an adhesive precursor composition according to any one of adhesive precursor compositions of the present disclosure onto a surface of the first substrate, contacting a surface of the second substrate to the exposed surface of the adhesive precursor composition and subjecting the adhesive precursor composition to actinic radiation to cure the adhesive precursor composition, thereby forming a heat-expandable temporary adhesive that temporarily bonds the first and second substrates together. The method of temporarily bonding two substrates may further include heating the heat-expandable temporary adhesive to a temperature, T, greater than Tᵢ, thereby expanding the heat-expandable microspheres, causing the heat-expandable temporary adhesive to expand, forming an expanded adhesive which facilitates debonding of at least one of the first and second substrates from the expanded adhesive. Facilitating debonding of at least one of the first and second substrates from the expanded adhesive includes at least one of (i) decreasing the adhesion between at least one of the first substrate and the expanded adhesive and the second substrate and the expanded adhesive, (ii) detaching, i.e. spontaneous debonding, at least one of the first substrate from the expanded adhesive and the second substrate from the expanded adhesive, (iii) causing cohesive failure in the expanded adhesive and (iv) peeling the temporary adhesive from one of the first and second substrates without damaging the at least one of the first and second substrates. In some embodiments, the decrease in adhesion between at least one of the first substrate and the expanded adhesive and the second substrate and the expanded adhesive may be at least 30% lower, at least 40% lower, at least 50 lower, at least 60% lower or even at least 70% lower than the adhesion prior to forming the expanded adhesive.

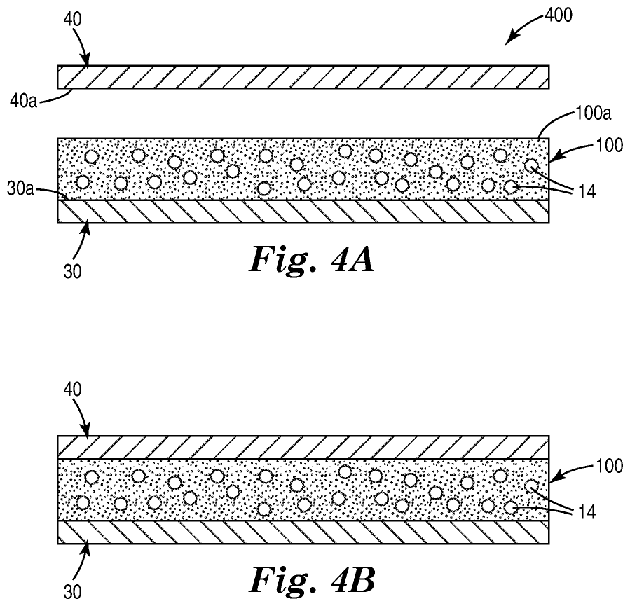

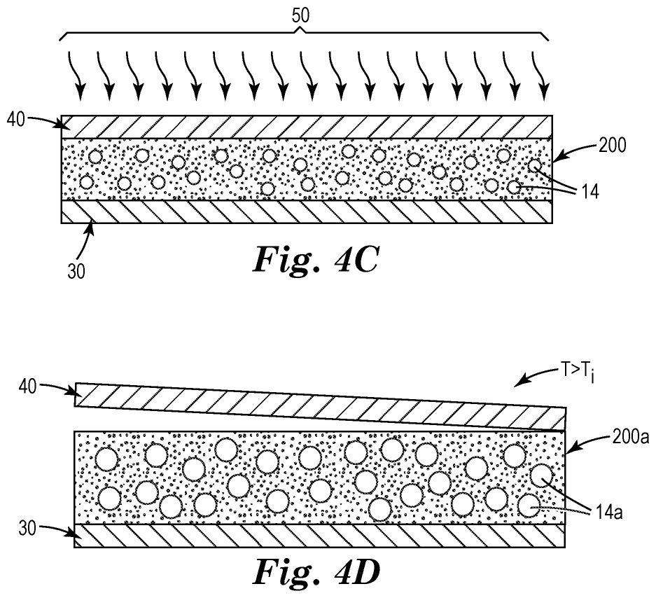

FIGS. 4A to 4D show method 400 of temporarily bonding two substrates, in accordance with some embodiments of the present disclosure. FIG. 4A shows a first substrate 30 having surface 30a, second substrate 40 having surface 40a, and an adhesive precursor composition 100 having heat-expandable microspheres 14. Adhesive precursor composition 100 is applied onto a surface 30a of first substrate 30. Adhesive precursor composition 100 has exposed surface 100a. First substrate 30 and second substrate 40 may be any of the first and second substrates previously discussed. In the next step of the method, shown in FIG. 4B, surface 40a of second substrate 40 is contacted to exposed surface 100a of adhesive precursor composition 100. At the application temperature, the adhesive precursor composition is a liquid, which facilitates flow and wetting of the surfaces of substrates 30 and 40. The adhesive precursor composition is then cured, for example, by actinic radiation or thermally. FIG. 4C shows subjecting the adhesive precursor composition 100 to actinic radiation 50 to cure the adhesive precursor composition, thereby forming a heat-expandable temporary adhesive 200 that contains heat-expandable microspheres 14. At least a portion of actinic radiation 50 passes through substrate 40 to cure adhesive precursor composition 100 and form heat-expandable temporary adhesive 200. Heat-expandable temporary adhesive 200 temporarily bonds the first and second substrates together. In some embodiments, at least one of the surface of the first substrate and the surface second substrate in contact with the adhesive precursor composition includes topography (not shown in FIGS. 4A to 4D). If one or both substrate surfaces include topography, the liquid may flow and wet the topographical features. As shown in FIG. 4D, the method may further include heating heat-expandable temporary adhesive 200 to a temperature, T, greater than Tᵢ, thereby expanding the heat-expandable microspheres 14 (shown as expanded microspheres 14a), causing the heat-expandable temporary adhesive 200 to expand, forming an expanded adhesive 200a which facilitates debonding of at least one of the first and second substrates from the expanded adhesive (shown as substrate 40 removed from expanded adhesive 200a). In some embodiments, temperature, T, is between 50° C. to 250° C., between 90° C. to 250° C. or between 130° C. to 250° C. Although the method exemplified in FIGS. 4A to 4D show first substrate 30 having the adhesive precursor composition applied to surface 30a, the substrates positions may be reversed and adhesive precursor composition 100 may be applied to surface 40a of second substrate 40 and surface 30a of first substrate 30 may then be contacted to exposed surface 100a of adhesive precursor composition 100.

The application of an adhesive precursor composition onto a surface of a substrate is not particularly limited and may be conducted by known techniques, for example, knife coating, spray coating, spin coating, roll coating, brush coating and the like. In one embodiment, adhesive precursor composition is applied by spin coating. Additionally, the method of temporarily bonding two substrates may be conducted at ambient conditions, e.g. room temperature and atmospheric pressure. In some embodiments, the adhesive precursor composition may be applied under vacuum and/or at an elevated temperature. In some embodiments, the first substrate and second substrate are bonded together under vacuum, i.e. at least one, up to and including all, of the steps of (i) applying an adhesive precursor composition onto a surface of a first substrate, (ii) contacting a surface of the second substrate to the exposed surface of the adhesive precursor composition and (iii) curing the adhesive composition, e.g. subjecting the adhesive precursor composition to actinic radiation to cure the adhesive precursor composition, are conducted under vacuum. Applying vacuum may facilitate the removal of entrained gases, e.g. air, in the adhesive precursor composition, remove bubbles therefrom and provide a more uniform coating of the adhesive precursor composition. In some embodiments, if the curing of the adhesive precursor composition is conducted and/or initiated by actinic radiation, the actinic radiation may pass through at least one of the first and second substrates, i.e. at least one of the first and second substrates is transparent to actinic radiation.

The method may further include conducting an industrial operation on at least one of the first and second substrate, after curing the adhesive precursor and prior to heating the heat-expandable temporary adhesive to a temperature, T, greater than Tᵢ, thereby expanding the heat-expandable microspheres, causing the heat-expandable temporary adhesive to expand. The industrial operation is not particularly limited and may include providing a coating on an exposed surface of at least one of the first and second substrate, conducting a material removal process, e.g. etching, grinding, polishing, on an exposed surface of at least one of the first and second substrate, and the like.

The present invention is more specifically described and explained by means of the following examples, in which all quantities and parts are by weight, unless otherwise noted. It is to be understood that the present invention is not limited to the Examples, and various changes and modifications may be made in the invention without departing from the spirit and scope thereof.

Materials

| Abbreviation | Description | Manufacturer |
|---|---|---|
| UV-3700B | Urethane acrylate oligomer, | Mitsubishi |
| | available under the trade | Chemical Co, Ltd, |
| | designation SHIKOH | Tokyo, Japan |
| | UV-3700B. UV-3700B. | |
| HDDA | Hexanediol diacrylate, | Osaka Organic |
| | available under the trade | Chemical Industry, Ltd., |
| | designation VISCOAT #230. | Osaka, Japan. |
| BA | Butyl Acrylate | Mitsubishi Chemical |
| | | Co, Ltd. |
| BZA | Benzyl acrylate, available | Osaka Organic |
| | under the trade | Chemical Industry, Ltd. |
| | designation VISCOAT #230. | |
| PEAM-1769 | Polyester acrylate | Designer Molecules, Inc., |
| | | San Diego, California |
| PEAM-645 | Polyester acrylate | Designer Molecules Inc. |
| Ominirad 851 | A photintiator, Bis(2,4,6- | IGM Resins, B.V., |
| | trimethylbenzoyl) | Waalwijk, Netherlands. |
| | phenylphosphine oxide | |
| Omnirad 369 | A photoinitiator, 2-Benzyl- | IGM Resins, B.V. |
| | 2-dimethylamino-1-(4-morpho- | |
| | linophenyl)-butanone. | |
| H750 | A heat expandable microsphere | Kureha Corporation, |
| | having an initiation temperature, | Tokyo, Japan. |
| | Tᵢ, of 138° C. and an | |
| | unexpanded microsphere | |
| | diameter of about 20 μm. | |
| S2640 | A heat expandable Microsphere | Kureha Corporation. |
| | having an initiation temperature, | |
| | Tᵢ, of 208° C. and an | |
| | unexpanded microsphere | |
| | diameter of about 21 μm. | |
| Revalpha | Heat releasable adhesive double | Nitto Denko Corporation, |
| | coated tape. | Osaka, Japan. |

### Examples

### Preparation of Adhesive Precursor Compositions

Ingredients for the adhesive precursor compositions of Examples 1 to 4 were prepared according to Table 1 and Examples 5 and 6 and Comparative Examples 7 and 8 (CE-7 and CE-8) were prepared according to Table 2. The ingredients, except for the oligomer, were put into a lightproof plastic bottle and stirred until the photo-initiator was completely dissolved. The oligomer was added to the bottle and the adhesive precursor composition was stirred.

TABLE 1
Formulations for Examples 1-4 (values in grams).

| | Example 1 | Example 2 | Example 3 | Example 4 |
|---|---|---|---|---|
| UV-3700B | 20 | 20 | 20 | — |
| HDDA | 5 | 5 | 5 | — |
| PEAM-1769 | — | — | — | 30 |
| PEAM-645 | — | — | — | 11.5 |
| BA | 8.33 | 8.33 | 8.33 | — |
| BZA | — | — | — | 7 |
| Omnirad 369 | 1.67 | 1.67 | 1.67 | — |
| Omnirad 851 | — | — | — | 1 |
| H750 | 10 | 5 | 20 | — |
| S2640 | — | — | — | 14 |

TABLE 2
Formulations for Comparative Examples 5-8 (values are in grams).

| | Example 5 | Example 6 | CE-7 | CE-8 |
|---|---|---|---|---|
| UV-3700B | 20 | 20 | 20 | — |
| HDDA | 5 | 5 | 5 | — |
| PEAM-1769 | — | — | — | 30 |
| PEAM-645 | — | — | — | 11.5 |
| BA | 8.33 | 8.33 | 8.33 | — |
| BZA | — | — | — | 7 |
| Omnirad 369 | 1.67 | 1.67 | 1.67 | — |
| Omnirad 851 | — | — | — | 1 |
| H750 | 2 | 25 | 0 | — |
| S2640 | — | — | — | 0 |

### Viscosity Test Method

The viscosity of the adhesive precursor compositions was measured using a cone and plate type viscometer available under the trade designation HAAKE, rheometer, from Thermo Fisher Scientific K.K., Minato-ku, Tokyo, Japan, The measurements were made at a temperature of 25° C., using a cone having a diameter of 35 mm and a cone angle of 1 degree, at a revolution speed of 1 degree/minute. The adhesive precursor compositions were placed between the cone and the plate followed by a 60 seconds delay, and then starting the rheometer. The viscosity reading was recorded 30 seconds after the start of measurement. Results are shown in Table 3.

### Fabrication of Heat Expandable Temporary Adhesives and Articles

In order to evaluate the examples, each example was used to adhere a silicon wafer to a substrate. A laminated stack comprising silicon wafer (first substrate), adhesive precursor composition and supporting glass substrate (second substrate) was prepared, using a spin coater, an automated bonding chamber having vacuum capabilities and a UV light curing chamber. First, about 6 g of the adhesive precursor composition from Example 1 was dispensed onto a silicon wafer which had been placed on the turn table of the spin coater with vacuum chuck to hold the wafer. The spin coater was then rotated at a specific rotational speed for 10 seconds. Depending on the viscosity of the adhesive precursor composition, the rotational speed was adjusted to obtain a 50 microns thick layer of adhesive precursor composition. The silicon wafer was then placed at the center portion on the bonding chamber. A glass wafer was placed in the lid of the chamber and held in place with pins. After closing the lid of the bonding chamber, vacuum applied to the surrounding atmosphere and the glass wafer was placed on the adhesive precursor coated silicon wafer, i.e. applied to the exposed surface of the adhesive precursor composition. During these steps, the pressure was reduced inside chamber to below 50 Pa. The article (wafer/adhesive precursor composition/glass substrate) was moved to a UV chamber and then exposed to UV radiation for 30 seconds, through the glass wafer, thereby forming a heat expandable temporary adhesive. The above procedure was repeated for Examples 2 to 5 and CE-7 and CE-8. The viscosity of Example 6 was too high for spin coating.

Comparative Example 9 (CE-9) was an evaluation of a commercially available tape product, Revalpha. For CE-9, the tape was applied onto the silicon wafer with roller, and then bonded to the glass substrate under vacuum.

### Debonding Test Method

The evaluation of the debonding process was as follows. A hot plate was pre-heated to 160° C. A laminate article (silicon wafer/cured adhesive/glass wafer relating to Examples 1 to 3, 5 and 6 and CE-7 to CE-9) was placed on the hot plate, with the silicon wafer in contact with the hot plate, in order to observe the debonding process through the glass substrate. For the laminate article that included the adhesive precursor composition of Example 4, which included S2640 expandable microspheres having a Tᵢ of 208° C., the temperature of the hot plate was raised to 220° C. Heat from the hot plate increased the temperature of the laminate article and caused the heat-expandable temporary adhesive (if present) to expand as its temperature increased above Tᵢ of the heat-expandable microspheres. After one minute, a small strip of an adhesive tape was applied to the edge of the silicon wafer. The tape, which hung over the edge of the wafer, was used as a tab to apply a force to the silicon wafer, by pulling up on the tape by hand. An assessment was made as to how easily the silicon wafer was separated from the expanded adhesive and/or how easily the glass wafer was separated from the expanded adhesive.

### Debonding Results

Laminate articles that include the adhesive precursors of Examples 1 to 3 required little or no force to remove the silicon wafer from the expanded adhesive. The expanded adhesive, after exposure to 160° C., debonded cleanly from the silicon wafer and then was peeled from the glass wafer without damaging the glass wafer. For the laminate article that included the adhesive precursor composition of Example 4, the expanded adhesive debonded cleanly from the silicon wafer and was then peeled from the glass wafer without damaging the glass wafer. Example 5 with its low loading of heat expandable particles (5.4 wt %), required the application of force to remove the adhesive from the silicon wafer. However, the silicon wafer was debonded from the expanded adhesive without damage to the silicon wafer. Example 6 could not be spin coated due to the high loading of heat expandable microspheres (41.8 wt. %). However, it is thought that adding a solvent to the adhesive composition, prior to spin coating, would facilitate the spin coating process (followed by solvent removal via drying) or use of a different coating technique, for example, knife coating, would enable the coating of this adhesive precursor composition. In Comparative Examples 7 and 8, which did not include any heat expandable microspheres, the silicon wafer did not debond from the adhesive. Table 3 includes silicon wafer debonding results.

TABLE 3

| | | Adhesive | Topo- | Silicon | |
|---|---|---|---|---|---|
| | Vis- | Precursor | graphy | Wafer | Surface |
| | cosity | Appli- | Filling | Debonding | obser- |
| | (cP) | cation | Test | Results | vation |
| Example 1 | 5200 | Spin coated | No | Debonded | Clean, no |
| | | at room | water | without force | adhesive |
| | | temperature | intrusion | at 160° C. | residue |
| Example 2 | 4810 | Spin coated | No | Debonded | Clean, no |
| | | at room | water | without | adhesive |
| | | temperature | intrusion | force | residue |
| | | | | at 160° C. | |
| Example 3 | 23200 | Spin coated | No | Debonded | Clean, no |
| | | with heated | water | without force | adhesive |
| | | adhesive | intrusion | at 160° C. | residue |
| Example 4 | 5700 | Spin coated | No | Debonded | Clean, no |
| | | at room | water | without force | adhesive |
| | | temperature | intrusion | at 220° C. | residue |
| Example 5 | 3040 | Spin coated | No | Debonded | n.a. |
| | | at room | water | with some | |
| | | temperature | intrusion | force at | |
| | | | | 160° C. | |
| Example 6 | 42500 | Not capable | n.a | n.a. | n.a. |
| | | of spin | | | |
| | | coating | | | |
| Comparative | 2300 | Spin coated | No | Did not | n.a. |
| Example 7 | | at room | water | debond at | |
| | | temperature | intrusion | 160° C. | |
| Comparative | 2370 | Spin coated | No | Did not | n.a. |
| Example 8 | | at room | water | debond at | |
| | | temperature | intrusion | 160° C. | |
| Comparative | n.a. | Rolled tape | Water | Debonded | Adhesive |
| Example 9 | | onto wafer | intrusion | without force | residue |
| | | | | at 160° C. | |

### Topography Filling Test Method

In order to determine the adhesive precursors composition's ability to conform to an uneven surface, i.e. topography, an evaluation was carried out as follows:
(A) a small amount of the adhesive precursor composition was dispensed using a syringe in a straight line along the length of a flat file having a rough surface made up of 150 μm high diagonal lines.
(B) The adhesive precursor composition was spread out with a spatula, thereby covering about half of the file surface longitudinally, and then cured by UV radiation. For CE-9, the adhesive tape was simply rolled onto the file.
(C) About 0.5 g of DI water was dispensed along the boundary line between the area covered with the cured adhesive or tape and the uncovered area of the file.
(D) Three minutes later, the DI water on the file surface was removed with a paper towel.
(E) The adhesive/tape was then removed and the file surface was observed to see whether there was intrusion of DI water, caused by capillary forces, underneath the cured adhesive or tape.

### Topography Filling Results.

It was found that the tape of CE-9 had water intrusion underneath the tape. Examples 1 to 4 and CE-5 to CE-8 did not experience water intrusion. Additionally, it was observed that Example 3 and Example 6 (containing a high load of heat expandable particles) could not be coated uniformly on the file, due to their high viscosity. In a second attempt, these two examples were pre-heated to 60° C. and then applied on the file. Example 3 formed a uniform layer, while Example 6, could not be coated evenly on the file.

### DMA Test Method

The storage modulus, loss modulus and tangent delta of the cured adhesives was measured using a dynamic viscoelasticity measuring device available under the trade designation RSA3, TA Instruments Japan Inc., Shinagawa-ku, Tokyo, Japan. The test conditions are as follows: distortion of 0.03/c, frequency of 1 kHz, an initial temperature of 0° C., a final temperature of 250° C., and a rate of temperature rise of 5° C./min.

### DMA Results

Dynamic mechanical analysis was carried out on the cured adhesive of Examples 1-4. The cured adhesives of Examples 1-3, which contained UV 3700B (20%) and hexanediol diacrylate (5%), each had a T_{tan δ max} value of about 8° C. The tan δ max value for these three examples was less than 1. The H750 expandable microspheres used in these examples had a Tᵢ equal to 138° C. Accordingly, the difference, Tᵢ−T_{tan δ max}, is 130° C. The cured adhesive of Example 4, which contained PEAM-1769 (30%) and PEAM-645 (11.5%), had a T_{tan δ max} value of about 48° C. The tan δ max value for this example was <1. S2640 expandable microspheres used in this example had a Tᵢ equal to 208° C. Accordingly, the difference Tᵢ−T_{tan δ max} is 160° C.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modifications and variations of the concepts herein disclosed may be resorted to by those of ordinary skill in the art, and that such modifications and variations are considered to be within the scope of embodiments of the present invention.

What is claimed:

1. An adhesive precursor composition, comprising:
a polyfunctional acrylate oligomer,
a reactive diluent including an acrylate monomer;
a photoinitiator; and
heat-expandable microspheres which are capable of expanding above an expansion initiation temperature, Tᵢ, wherein the adhesive precursor composition is a liquid at temperature, Tₐ, wherein Tₐ is less than Tᵢ, and the reaction product of the adhesive precursor composition is a heat-expandable temporary adhesive having a maximum value of tan δ at a temperature, T_{tan δ max}, wherein T_{tan δ max} is less than Tᵢ.

2. The adhesive precursor composition of claim 1, wherein T_{tan δ max} is at least 10° C. less than Tᵢ.

3. The adhesive precursor composition of claim 1, wherein Tₐ is at least 10° C. greater than a melting point of the adhesive precursor composition.

4. The adhesive precursor composition of claim 1, wherein the polyfunctional acrylate oligomer is selected from at least one of a polyester acrylate oligomer and a urethane acrylate oligomer.

5. A heat-expandable temporary adhesive comprising the reaction product of an adhesive precursor composition according to claim 1.

6. An article comprising:
a first substrate;
a second substrate; and
a heat-expandable temporary adhesive disposed therebetween, wherein the heat-expandable temporary adhesive is the reaction product of an adhesive precursor composition according to claim 1.

7. A method of temporarily bonding two substrates, comprising:
providing a first and second substrate;
applying an adhesive precursor composition according to claim 1 onto a surface of the first substrate;
contacting a surface of the second substrate to the exposed surface of the adhesive precursor composition; and
subjecting the adhesive precursor composition to actinic radiation to cure the adhesive precursor composition, thereby forming a heat-expandable temporary adhesive that temporarily bonds the first and second substrates together.

8. The method of claim 7, further comprising heating the heat-expandable temporary adhesive to a temperature, T, greater than Tᵢ, thereby expanding the heat-expandable microspheres, causing the heat-expandable temporary adhesive to expand, forming an expanded adhesive which facilitates debonding of at least one of the first and second substrates from the expanded adhesive.

9. The method of claim 8, wherein temperature, T, is between 130° C. to 250° C.

10. The method of claim 7, wherein facilitating debonding of at least one of the first and second substrates from the expanded adhesive includes at least one of (i) decreasing the adhesion between at least one of the first substrate and the expanded adhesive and the second substrate and the expanded adhesive, (ii) detaching at least one of the first substrate from the expanded adhesive and the second substrate from the expanded adhesive, (iii) causing cohesive failure in the adhesive, and (iv) peeling the temporary adhesive from one of the first and second substrates without damaging the at least one of the first and second substrates.
